(19) United States
(12) Patent Application Publication
(10) Pub. No.: US 2025/0190772 A1
(43) Pub. Date: Jun. 12, 2025

(54) REAL-TIME PARAMETER TUNING

(71) Applicant: ADVANCED MICRO DEVICES, INC., Santa Clara, CA (US)

(72) Inventors: Yu Ma, Shanghai (CN); XiaoChao Wei, Shanghai (CN)

(21) Appl. No.: 18/531,035

(22) Filed: Dec. 6, 2023

(51) Int. Cl. G06N 3/063

(52) U.S. Cl. CPC G06N 3/063

(57) ABSTRACT

A processor system includes a plurality of hardware components and an operational parameter tuning circuit. The operational parameter tuning circuit is configured to perform a first adjustment action, during a first time interval, that adjusts one or more operational parameters of at least one hardware component of the plurality of hardware components based on a current state of the at least one hardware component and a policy that maps adjustment actions to a plurality of different states for the at least one hardware component.

### BACKGROUND

Central processing units (CPUs), graphics processing units (GPUs), accelerated processing devices (APDs), and other related integrated circuits are typically designed with static parameters that determine the allocation of computational resources, the activation or deactivation of specific features, and the like. These static parameters are often set during the design or runtime phase and remain unaltered during various state changes of the chip.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an example processing system in accordance with some implementations.

FIG. 2 is a block diagram of an operational parameter tuning circuit implemented by the processing system of FIG. 1 in accordance with some implementations.

FIG. 3 is a diagram illustrating a machine learning (ML) module employing a neural network for implementation by the operational parameter tuning circuit of FIG. 2 in accordance with some implementations.

FIG. 4 is a diagram illustrating one example of the operational parameter tuning circuit of FIG. 2 adjusting operational parameters of an operating environment in real-time based on changes in the state associated with the operating environment in accordance with some implementations.

FIG. 5 is a flow diagram illustrating an example method for adjusting operational parameters of an operating environment in real-time based on changes in the state associated with the operating environment in accordance with some implementations.

### DETAILED DESCRIPTION

Traditionally, the operation of CPUs, GPUs, APDs, and similar integrated circuits has been governed by predefined operational parameters. These parameters, set during the chip's initialization or boot phase, determine how and when the chip will allocate computational resources, manage features of the chip during its operational cycle, and the like. In conventional systems, resources such as cores, arithmetic logic units (ALUs), and cache memories (L1, L2, L3) are allocated based on static operational parameters, usually set at startup or boot. In GPUs or APDs, shader units, texture units, raster operations pipelines, and memory allocation are typically governed by similar static operational parameters. Also, features embedded within CPUs, GPUs, and APDs, such as specialized instruction sets, security measures, or power management techniques, are traditionally activated or deactivated based on static criteria set at initialization. As a result, the adaptability of these features to changing environmental states, such as varying workloads or operating conditions, is limited.

The static and universal nature of operational parameters presents several challenges. For example, with fixed parameters an integrated circuit cannot adapt efficiently to varying computational requirements, leading to non-optimal performance. Also, predefined resource allocation at the integrated circuit may not align with real-time demands, resulting in some resources to be underutilized and others to be overstrained. For example, example, consider a memory control feature referred to as opportunistic write through (OWT). A write through caching policy means that every time data is written into the cache, the data is also concurrently written to a backing store, such as main memory. An opportunistic write through refers to a write through caching policy that is activated when certain conditions are satisfied, such as a number of pending writes to the memory controller being under a first specified threshold parameter, a number of available pool tokens in a data channel to the memory controller being greater than a second specified threshold, and a number of available pool tokens being available in a request channel to the memory controller being greater than a third specified threshold. In this example, the specified thresholds are operational parameters that are typically static in conventional systems. As such, the OWT feature of a memory controller is enabled or disabled according to the same operational parameter values regardless of the current state of the operating environment. Stated differently, even though memory performance could be increased by adjusting the specified OWT activation thresholds based on the current state of the operating environment, conventional systems universally apply the same specified thresholds regardless of the current state of the operating environment.

In another example, a graphics processing pipeline implements an operational parameter to control the number of primitives that are binned before sending the primitives to another processing block, such as a depth processing block. The higher the value set for this operational parameter, the better cache utilization and pixel rate. However, conventional systems typically use the same value for the operational parameter regardless of the state of the data being processed, such as current primitive size, data format, etc. Therefore, even though cache utilization and pixel rate could be improved by adjusting the number of primitives that are binned based on the current state of the data being processed, conventional systems do not provide this implement since they typically implement a static binning parameter regardless of the data being processed

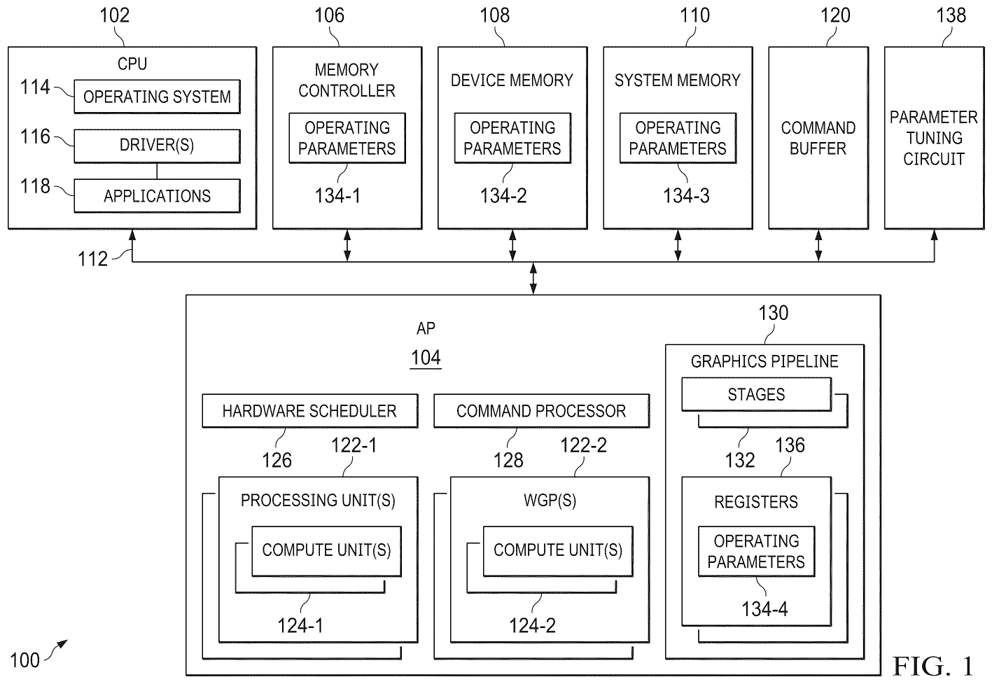

To improve processor (e.g., CPU, GPU, APD, or the like) and overall system performance, FIGS. 1-5 illustrate systems and methods implementing techniques for adaptively adjusting or tuning operational parameters in real-time based on detected changes in the operating environment. As described in greater detail below, one or more operational parameter tuning circuits (herein referred to as “parameter tuning circuits” for brevity) are implemented at one or more processors (e.g., a CPU, a GPU, an APD or the like), a memory controller, a chip (e.g., system-on-a-chip (SoC) having one processing devices, or the like. The parameter tuning circuit(s) is configured to automatically adjust operational parameters of the processing system, or specific components of the operation system such as a processor, a memory controller, a graphics pipeline, a combination thereof, or the like, in response to changes in the operating environment.

In at least some implementations, the parameter tuning circuit implements one or more machine learning mechanisms to adjust operational parameters in real-time based on a current state of the operating environment. For example, in a least some implementations, the parameter tuning circuit implements reinforcement learning or deep reinforcement learning. In these implementations, the parameter tuning circuit uses reinforcement learning to learn a policy, which is a mapping from states to actions. For example, if the parameter tuning circuit is configured to adjust operational parameters such as the thresholds for enabling or disabling opportunistic write-through, the parameter tuning circuit learns when to increase or decrease one or more of the thresholds based on the state of the operating environment, such as how busy the memory controller is as represented by one or more of the number of pending writes to the memory controller, the number of pool tokens available in the data channel to the memory controller, or the number of pool tokens available in the request channel to the memory controller. In another example, if the parameter tuning circuit is configured to adjust operational parameters such as the binning parameter described above, the parameter tuning circuit learns when to increase or decrease the value of the binning parameter based on the state of the operating environment, such as one or more of the current primitive size, data format, etc.

The parameter tuning circuit, in at least some implementations, learns the policy by taking certain actions, such as increasing or decreasing values of the operational parameters, and receiving rewards or penalties from the operating environment for those actions. The parameter tuning circuit uses the received reward or penalty to update the policy. For example, in an implementation where the parameter tuning circuit is configured to adjust operational parameters for enabling or disabling the OWT feature of a memory controller, the parameter tuning circuit takes an action, such as adjusting one or more of the thresholds for enabling or disabling the OWT feature, for the current state (e.g., workload state) of the memory controller. The parameter tuning circuit or a separate monitoring mechanism then measures the impact the action had on memory performance metrics, such as latency and throughput). Based on the collected metrics, a reward function computes a reward or penalty value. In this example, the reward function is configured to generate higher rewards for better performance and penalties (negative rewards) for degraded performance. The environment, which includes both the system or component being optimized and the monitoring mechanism, returns the computed reward value to the parameter tuning circuit along with the new state. The parameter tuning circuit uses this reward signal to update the policy (or value function) learning over time to make better decisions. This process of action execution, state transition, reward computation, and policy updating continues iteratively. Over many episodes (cycles of interactions), the parameter tuning circuit learns how to best adjust the operational parameters of interest in real-time based on state of the system, component, or feature being optimized.

FIG. 1 is a block diagram illustrating a processing system 100, including a parameter tuning circuit(s) configured to adjust operational parameters of the processing system 100 (or a component thereof) in real-time based on a current state of the component or feature of the processing system 100 being optimized. It is noted that the number of components of the processing system 100 varies from implementation to implementation. In at least some implementations, there is more or fewer of each component/subcomponent than the number shown in FIG. 1. It is also noted that the processing system 100, in at least some implementations, includes other components not shown in FIG. 1. Additionally, in other implementations, the processing system 100 is structured in other ways than shown in FIG. 1. Also, components of the processing system 100 are implemented as hardware, circuitry, firmware, software, or any combination thereof.

In the depicted example, the processing system 100 includes a central processing unit (CPU) 102, an accelerator processing unit (also referred to herein as “accelerator processor 104” or “APD 104”) 104, a memory controller 106, a device memory 108 utilized by the APD 104, and a system memory 110 shared by the CPU 102 and the APD 104. The APD 104 includes, for example, an individual or a plurality of a vector processor, a co-processor, a graphics processing unit (GPU), a general-purpose GPU (GPGPU), a non-scalar processor, a parallel processor, an artificial intelligence (AI) processor, an inference engine, a machine-learning processor, another multithreaded processing unit, a scalar processor, a serial processor, a programmable logic device (e.g., a simple programmable logic device, a complex programmable logic device, a field programmable gate array (FPGA), or any combination thereof. The APD 104 and the CPU 102, in at least some implementations, are formed and combined on a single silicon die or package to provide a unified programming and execution environment. In other implementations, the APD 104 and the CPU 102 are formed separately and mounted on the same or different substrates. In at least some implementations, the APD 104 is a dedicated GPU, one or more GPUs including several devices, or one or more GPUs integrated into a larger device.

The memory controller 106, in at least some implementations, includes any suitable hardware for interfacing with memories 108, 110. The memories 108, 110 include any of a variety of random access memories (RAMs) or combinations thereof, such as a double-data-rate dynamic random access memory (DDR DRAM), a graphics DDR DRAM (GDDR DRAM), and the like. The APD 104 communicates with the CPU 102, the device memory 108, and the system memory 110 via a communications infrastructure 112, such as a bus. The communications infrastructure 112 interconnects the components of the processing system 100 and includes one or more of a peripheral component interconnect (PCI) bus, extended PCI (PCI-E) bus, advanced microcontroller bus architecture (AMBA) bus, advanced graphics port (AGP), or other such communication infrastructure and interconnects. In some implementations, communications infrastructure 112 also includes an Ethernet network or any other suitable physical communications infrastructure that satisfies an application's data transfer rate requirements.

As illustrated, the CPU 102 maintains, in memory, one or more control logic modules for execution by the CPU 102. The control logic modules, in at least some implementations, include an operating system 114, one or more drivers 116 (e.g., a user mode driver, a kernel mode driver, etc.), and applications 118. These control logic modules control various features of the operation of the CPU 102 and the APD 104. For example, the operating system 114 directly communicates with hardware and provides an interface to the hardware for other software executing on the CPU 102. The driver(s) 116, for example, controls the operation of the APD 104 by, for example, providing an application programming interface (API) to software (e.g., applications 118) executing on the CPU 102 to access various functionality of the APD 104. For example, in at least some implementations, an application 118 utilizes a graphics API to invoke a driver 116. The driver 116 issues one or more commands to the APD 104 for rendering one or more graphics primitives into displayable graphics images. Based on the graphics instructions issued by the application 118 to the driver 116, the driver 116 formulates one or more graphics commands that specify one or more operations for the APD 104 to perform for rendering graphics. In at least some implementations, the driver 116 is a part of the application 118 running on the CPU 102. In one example, the driver 116 is part of a gaming application running on the CPU 102. In another example, the driver 116 is part of the operation system 114 running on the CPU 102. The graphics commands generated by the driver 116 include graphics commands intended to generate an image or a frame for display. The driver 116 translates standard code received from the API into a native format of instructions understood by the APD 104. Graphics commands generated by the driver 116 are sent to the APD 104 for execution. The APD 104 executes the graphics commands and uses the results to control what is displayed on a display screen.

In at least some implementations, the CPU 102 sends graphics commands, compute commands, or a combination thereof intended for the APD 104 to a command buffer 120. Although depicted in FIG. 1 as a separate component for ease of illustration, the command buffer 120, in at least some implementations, is located in device memory 108, system memory 110, or a separate memory coupled to the communication infrastructure 112. The command buffer 120 temporarily stores a stream of graphics commands that include input to the APD 104. The stream of graphics commands includes, for example, one or more command packets and/or one or more state update packets.

The APD 104, in at least some implementations, accepts both compute commands and graphics rendering commands from the CPU 102. The APD 104 includes any cooperating collection of hardware, software, or a combination thereof that performs functions and computations associated with accelerating graphics processing tasks, data-parallel tasks, nested data-parallel tasks in an accelerated manner with respect to resources such as conventional CPUs, conventional GPUs, and combinations thereof. For example, in at least some implementations, the APD 104 executes commands and programs for selected functions, such as graphics operations and other operations that are particularly suited for parallel processing. In general, the APD 104 is frequently used for executing graphics pipeline operations, such as pixel operations, geometric computations, and rendering an image to a display. In some implementations, the APD 104 also executes compute processing operations (e.g., those operations unrelated to graphics such as video operations, physics simulations, computational fluid dynamics, etc.), based on commands or instructions received from the CPU 102. For example, such commands include special instructions that are not typically defined in the instruction set architecture (ISA) of the APD 104. In some implementations, the APD 104 receives an image geometry representing a graphics image, along with one or more commands or instructions for rendering and displaying the image. In various implementations, the image geometry corresponds to a representation of a two-dimensional (2D) or three-dimensional (3D) computerized graphics image.

In various implementations, the APD 104 includes one or more processing units 122 (illustrated as processing unit 122-1 and processing unit 122-2). One example of a processing unit 122 is a workgroup processor (WGP) 122-2. In at least some implementations, a WGP 122-2 is part of a shader engine (not shown) of the APD 104. Each of the processing units 122 includes one or more compute units 124 (illustrated as compute unit 124-1 and compute unit 124-2), such as one or more stream processors (also referred to as arithmetic-logic units (ALUs) or shader cores), one or more single-instruction multiple-data (SIMD) units, one or more logical units, one or more scalar floating point units, one or more vector floating point units, one or more special-purpose processing units (e.g., inverse-square root units, since/cosine units, or the like), a combination thereof, or the like. Stream processors are the individual processing elements that execute shader or compute operations. Multiple stream processors are grouped together to form a computer unit or a SIMD unit. SIMD units, in at least some implementations, are each configured to execute a thread concurrently with execution of other threads in a wavefront (e.g., a collection of threads that are executed in parallel) by other SIMD units, e.g., according to a SIMD execution model. The SIMD execution model is one in which multiple processing elements share a single program control flow unit and program counter and thus execute the same program but are able to execute that program with different data. The number of processing units 122 implemented in the APD 104 is configurable. Each processing unit 122 includes one or more processing elements such as scalar and or vector floating-point units, arithmetic and logic units (ALUs), and the like. In various implementations, the processing units 122 also include special-purpose processing units (not shown), such as inverse-square root units and sine/cosine units.

Each of the one or more processing units 122 executes a respective instantiation of a particular work item to process incoming data, where the basic unit of execution in the one or more processing units 122 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing unit 122.

The APD 104 issues and executes work-items, such as groups of threads executed simultaneously as a “wavefront”, on a single SIMD unit. Wavefronts, in at least some implementations, are interchangeably referred to as warps, vectors, or threads. In some implementations, wavefronts include instances of parallel execution of a shader program, where each wavefront includes multiple work items that execute simultaneously on a single SIMD unit in line with the SIMD paradigm (e.g., one instruction control unit executing the same stream of instructions with multiple data). A hardware scheduler (HWS) 126 is configured to perform operations related to scheduling various wavefronts on different processing units 122 and compute units 124, and performing other operations to orchestrate various tasks on the APD 104.

In at least some implementations, the processing system 100 also includes one or more command processors 128 that act as an interface between the CPU 102 and the APD 104. The command processor 128 receives commands from the CPU 102 and pushes the commands into the appropriate queues or pipelines for execution. The hardware scheduler 126 schedules the queued commands, also referred to herein as work items (e.g., a task, a thread, a wavefront, a warp, an instruction, or the like), for execution on the appropriate resources, such as the compute units 124, within the APD 104. In at least some implementations, the hardware scheduler 126 and the command processor 128 are separate components, whereas, in other implementations, the hardware scheduler 126 and the command processor 128 are the same component. Also, in at least some implementations, one or more of the processing units 122 include additional schedulers. For example, a WGP 122-2, in at least some implementations, includes a local scheduler (not shown) that, among other things, allocates work items to the compute units 124-2 of the WGP 122-2.

In at least some implementations, the APD 104 includes a memory cache hierarchy (not shown) including, for example, L1 cache and a local data share (LDS), to reduce latency associated with off-chip memory access. The LDS is a high-speed, low-latency memory private to each processing unit 122. In some implementations, the LDS is a full gather/scatter model so that a workgroup writes anywhere in an allocated space.

The parallelism afforded by the one or more processing units 122 is suitable for graphics-related operations such as pixel value calculations, vertex transformations, tessellation, geometry shading operations, and other graphics operations. A graphics processing pipeline 130 accepts graphics processing commands from the CPU 102 and thus provides computation tasks to the one or more processing units 122 for execution in parallel. In at least some implementations, the graphics pipeline 130 includes a number of stages 132, each configured to execute various aspects of a graphics command. Some graphics pipeline operations, such as pixel processing and other parallel computation operations, require that the same command stream or compute kernel be performed on streams or collections of input data elements. Respective instantiations of the same compute kernel are executed concurrently on multiple compute units 124 in the one or more processing units 122 to process such data elements in parallel. As referred to herein, for example, a compute kernel is a function containing instructions declared in a program and executed on a processing unit 122 of the APD 104. This function is also referred to as a kernel, a shader, a shader program, or a program.

As described above, the operation of the processing system 100 and its components, such as the CPU 102, the APD 104, the memory controller 106, and the graphics pipeline 130, is typically governed by operational parameters 134 (illustrated as operational parameters 134-1 to 134-4). Operational parameters 134 are the values that control the execution behavior of the processing system 100 as a whole or individual components of the processing system 100. Examples of execution behavior include enabling or disabling specific features (e.g., opportunistic write-through) of component, assigning resources to a task, controlling primitive binning, allocating memory, setting cache sizes, setting refresh rates of DRAM, setting queue lengths, executing specialized instruction sets, implementing security measures, performing power management techniques, and the like. In at least some implementations, operational parameters 134 are stored or maintained in the device memory 106, the system memory 108, registers 136, on-chip storage, cache, the component (e.g., CPU 102, APD 104, memory controller 106, hardware scheduler 126, or the like) being optimized, the basic input/output system (BIOS), firmware, configuration files, on-chip storage, as part of a driver, a combination thereof, or the like.

In conventional systems, many operational parameters are predefined and static such that they are universally applied regardless of the current state of the system or component they control. As such, these fixed operational parameters cannot adapt efficiently to varying computational requirements, leading to non-optimal performance and underutilization of system resources. However, the processing system 100 implements or more parameter tuning circuits 138 that are configured to automatically adjust operational parameters 134 in response to changes in the operating environment. In at least some configurations, a single parameter tuning circuit 138 is implemented for the entire processing system 100 or a specified component thereof, whereas, in other configurations, multiple parameter tuning circuits 138 are implemented. Also, although the example illustrated in FIG. 1 shows the parameter tuning circuit 138 as being a separate component of the processing system 100, in at least some implementations, one or more parameter tuning circuits 138 are disposed within the component being optimized. For example, in at least some implementations, a parameter tuning circuit 138 is implemented within the CPU 102, the APD 104, the memory controller 108, the hardware scheduler 126, the command processor 128, the graphics pipeline 130, or the like.

The parameter tuning circuit(s) 138, in at least some configurations, is implemented using any type of applicable circuitry including application-specific integrated circuits/circuitry (ASICs), one or more programmable logic devices, or a combination thereof, or the like. In other configurations, the parameter tuning circuit 138 is a parameter tuning component implemented as hardware, firmware, a firmware-controlled microcontroller, software executable on one or more processors, as part of a driver, a combination thereof, or the like. In at least some implementations, the parameter tuning circuit 138 is application-aware, whereas, in other implementations, the parameter tuning circuit 138 is application-aware. If the parameter tuning circuit 138 is application-aware, a parameter tuning circuit 138, in at least some implementations, has a one-to-one mapping with an application 118. However, if the parameter tuning circuit 138 is application-unaware, a single parameter tuning circuit 138, in at least some implementations, is able to adjust operational parameters 134 associated with multiple applications 118.

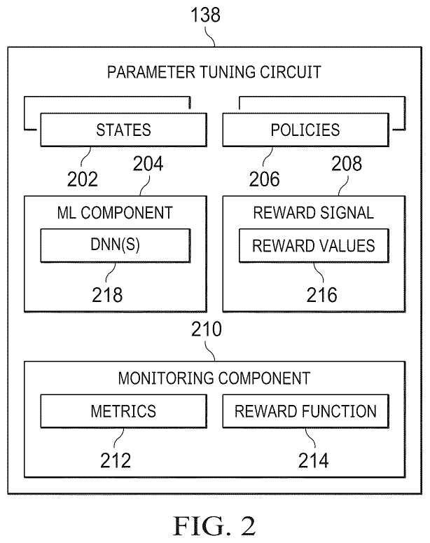

As shown in FIG. 2, the parameter tuning circuit 138 takes as input the current state 202 of the component being optimized and adjusts one or more operational parameters 134 of the component in real-time. As used herein, the term “state” refers to a specific set of conditions or attributes at a given moment in time that describes the status, configuration, or current values of the processing system 100 or its components. This encapsulation of conditions, in at least some implementations, encompasses various parameters, including operational control values, register contents, memory allocations, configurations, and other dynamic or static attributes relevant to the behavior or performance of the processing system 100 or its components. A state 202 serves as a snapshot that captures the essence of the present situation of the processing system 100 or its components. Stated differently, the state 202 represents the immediate environment in which the parameter tuning circuit 138 operates. Examples of state 202 include the workload/busy state of the component, the thermal state of the component, the current clock rate or frequency of the component, the current computing resources allocated to the component, performance metrics of the component, or the like.

In at least some implementations, the parameter tuning circuit 138 implements one or more machine learning (ML) components 204 (also referred to herein as “machine learning (ML) circuits 204”) to adjust operational parameters 134 in real-time based on the current state 202 of the component of the processing system 100 being optimized (e.g., the operating environment). In at least some implementations, the ML component 204 implements reinforcement learning or deep reinforcement learning. When implementing reinforcement learning, the parameter tuning circuit 138 learns to take actions with respect to a current state 202 of the operating environment such that a cumulative reward is maximized. For example, the parameter tuning circuit 138 learns to adjust one or more operational parameters 134 of the processing system component being optimized based on the current state 202 of the component. These learned actions are maintained by the parameter tuning circuit 138 as one or more operational parameter adjustment policies 206 (herein referred to as “adjustment policies 206” or “policies 206” for brevity), which are a mapping from states 202 to operational parameter adjustment actions.

The parameter tuning circuit 138 learns a policy 206 by performing an action, such as adjusting (e.g., increasing or decreasing values of) one or more operational parameters 134, based on the current state 202 and receiving a reward signal 208 for those actions. In at least some implementations, the reward signal 208 provides a measure of the immediate benefit or consequence of an action. When the reward signal 208 represents a reward, the signal indicates a positive consequence or positive/desired outcome resulting from the action. When the signal 208 represents a penalty, the signal indicates a negative consequence or negative/undesired outcome resulting from the action. The parameter tuning circuit 138 uses the reward signal 208 to update the policy 206.

For example, in an implementation where the parameter tuning circuit 138 is configured to adjust operational parameters 134 for enabling or disabling an OWT feature of the memory controller 106, the parameter tuning circuit 138 takes an action, such as adjusting (e.g., increasing or decreasing) one or more thresholds for enabling or disabling the OWT feature based on the current state 202 of the memory controller 106. Examples of the current state 202 include the current number of pending writes to the memory controller 106, the current number of pool tokens available in a data channel to the memory controller 106, and the current number of pool tokens available in a request channel to the memory controller 106. Examples of the thresholds include a first threshold for the number of pending writes to the memory controller 106, a second threshold for the number of pool tokens available in a data channel to the memory controller 106, and a third threshold for the number of pool tokens available in a request channel to the memory controller 106. In at least some implementations, when the number of pending writes is less than the first threshold, the number of pool tokens available in the data channel is greater than the second threshold, and the number of pool tokens in the request channel is greater than the third threshold, the OWT feature is enabled, otherwise the OWT feature is disabled. Stated differently, the OWT feature is either enabled or disabled based on how busy (workload state) the memory controller 106 currently is.

A monitoring component 210 (also referred to as a “monitoring circuit 210”), which is implemented in, or external to, the parameter tuning circuit 138, measures the impact the action had on the operating environment, such as the component controlled by the adjusted operational parameters 134. In the current example, the monitoring component 210 measures memory performance metrics, such as latency and throughput. Based on the collected metrics 212, a reward function 214 computes a reward value 216. The reward function 214, in at least some implementations, is part of or external to the monitoring component 210. In the current example, the reward function 214 is configured to generate higher rewards for better memory performance and penalties (negative rewards) for degraded memory performance. The monitoring component 210 (or another component), sends a reward signal 208 including the computed reward value 216, which includes either a reward or a penalty, to the parameter tuning circuit 138 along with a new state 202. The new state 202 refers to the subsequent configuration or representation of the processing system component after the parameter tuning circuit 138 has taken an action. In the current example, the new state 202 includes a current number of pending writes or pool tokens in the data or request channels. The parameter tuning circuit 138 uses the reward signal 208 to update the policy 206 or value function, which is an estimation of expected rewards or penalties from future selections, thereby learning to make better decisions over time. In at least some implementations, the parameter tuning circuit 138 performs this process of action execution, state transition, reward computation, and policy updating in a continuous and iterative manner. Over many episodes (cycles of interactions), the parameter tuning circuit 138 learns how to best adjust the operational parameters 134 of interest in real-time based on the current state 202 of the component being optimized. For example, the parameter tuning circuit 138 learns how to increase, decrease, or maintain the OWT thresholds based on the current state 202 such that memory performance is improved (or at least maintained) when compared to, for example, the previous state 202.

In at least some implementations, the ML component 204 of the parameter tuning circuit 138 implements deep reinforcement learning. In these implementations, the ML component 204 implements one or more neural networks, such as deep neural network(s) (DNNs) 218, to represent the policy 206 (or value functions). DNNs 218 allow the parameter tuning circuit 138 to process large amounts of information including raw states (e.g., raw pixel data from a video game) and high-dimensional data, and learn from intricate patterns. When implementing deep reinforcement learning, the parameter tuning circuit 138 initializes the DNN(s) 218 with random weights. The parameter tuning circuit 138 observes the current state 202 of the processing system component being optimized. This state 202, in one example, is raw data such as pixels from a screen or other types of data. The observed state 202 is passed through the DNN 218 to extract meaningful features or to obtain a compact representation of the state 202. The DNN 218 processes the observed state 202 and outputs, for example, a representation of the next action, a probability distribution over all possible actions, or outputs a value for each possible action. The parameter tuning circuit 138 selects an adjustment action based on the output of the DNN 218 and adjusts the operational parameters 134 of interest. The monitoring component 210 (or another component) returns a reward value 216 and a new state 202 as feedback based on the taken action. The parameter tuning circuit 138 uses the reward value 216 and the output (predictions) of the DNN 218 to compute the loss or error. In at least some implementations, the parameter tuning circuit 138 performs backpropagation to adjust the weights and biases to minimize the error. The new state 202 received from the monitoring component 210 becomes the current state 202 for the next iteration and the above process is repeated. This iterative process, in at least some implementations, ends after a certain number of iterations, once convergence occurs, or some other stopping criterion is satisfied.

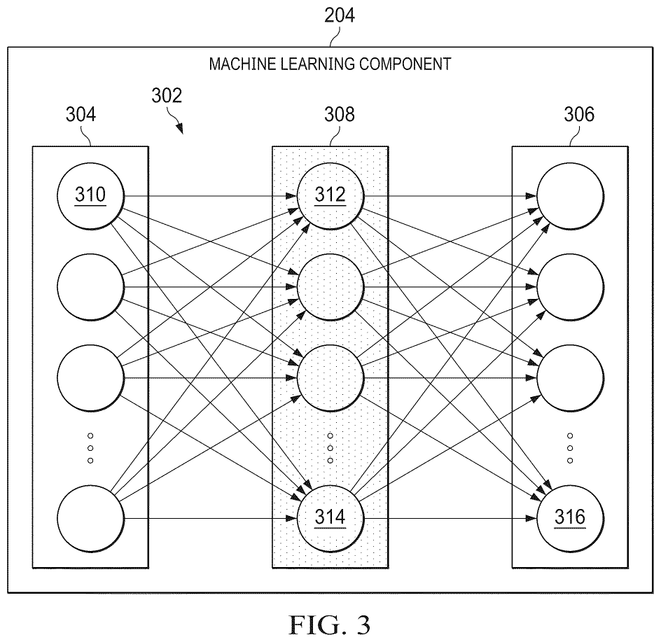

FIG. 3 shows one example of the ML component 210 implementing a neural network, such as a DNN 218, for predicting how to adjust one or more operational parameters 134 in real-time based on the current state 202 of the processing system component being optimized. In the depicted example, the ML component 210 implements at least one deep neural network (DNN) 218 with groups of connected nodes (e.g., neurons and/or perceptrons) organized into three or more layers. The nodes between layers are configurable in a variety of ways, such as a partially connected configuration where a first subset of nodes in a first layer is connected with a second subset of nodes in a second layer, a fully connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based on adaptive learning. Using the DNN 218, the ML component 210 performs a variety of different types of analysis, including single linear regression, multiple linear regression, logistic regression, stepwise regression, binary classification, multiclass classification, multivariate adaptive regression splines, locally estimated scatterplot smoothing, a combination thereof, and so forth.

In at least some implementations, the DNN 218 is trained to output predicted actions for adjusting operational parameters 134 of a processing system component in real-time based on the current state 202 of the processing system component. The DNN 218, in at least some implementations, is trained based on the loss computation, backpropagation, and iterative processes described above with respect to FIG. 2 The ML component 210 uses one or both of statistical analysis and adaptive learning to map an input to an output. For instance, the ML component 210 uses characteristics learned from training data to correlate an unknown input to an output that is statistically likely within a threshold range or value. This allows the ML component 210 to receive complex input and identify a corresponding output.

In the depicted example, the DNN 218 includes an input layer 304, an output layer 306, and one or more hidden layers 308 positioned between the input layer 304 and the output layer 306. Each layer has an arbitrary number of nodes, where the number of nodes between layers can be the same or different. That is, the input layer 304 can have the same number and/or a different number of nodes as output layer 306, the output layer 306 can have the same number and/or a different number of nodes than the one or more hidden layer 308, and so forth.

Node 310 corresponds to one of several nodes included in input layer 304, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 310 can determine whether to pass the processed input data to one or both of node 312 and node 314 of hidden layer 308. Alternatively or additionally, node 310 passes the processed input data to nodes based upon a layer connection architecture. This process can repeat throughout multiple layers until the DNN 218 generates an output using the nodes (e.g., node 316) of output layer 306.

A neural network can also employ a variety of architectures that determine what nodes within the neural network are connected, how data is advanced and/or retained in the neural network, what weights and coefficients the neural network is to use for processing the input data, how the data is processed, and so forth. These various factors collectively describe a neural network architecture configuration, such as the neural network architecture configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architecture configuration can include a variety of parameter configurations that influence how the DNN 218 or other neural network processes input data.

A neural network architecture configuration of a neural network can be characterized by various architecture and/or parameter configurations. To illustrate, consider an example in which the DNN 218 implements a convolutional neural network (CNN). Generally, a convolutional neural network corresponds to a type of DNN in which the layers process data using convolutional operations to filter the input data. Accordingly, the CNN architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where the neural network pools data in the layers of data processing. A pooling parameter that indicates “max pooling,” for instance, configures the neural network to pool by selecting a maximum value from the grouping of data generated by the nodes of a first layer and using the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data. A layer parameter specifies layer connections and/or layer types, such as a fully-connected layer type that indicates to connect every node in a first layer (e.g., output layer 306) to every node in a second layer (e.g., hidden layer 308), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architecture configuration can include any suitable type of configuration parameter that a DNN can apply that influences how the DNN processes input data to generate output data. As such, the ML component 210 allows parameter tuning circuit 138 to perform one or more machine learning operations for adjusting operational parameters 134 of a system component in real-time based on the current state 202 of the component.

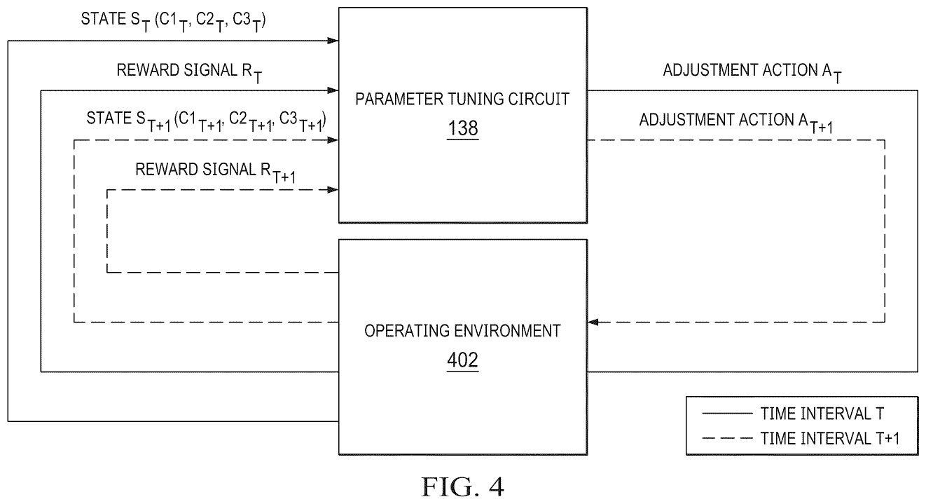

FIG. 4 illustrates one example of the parameter tuning circuit 138 adjusting operational parameters 134 of an operating environment, such as a component of the processing system 100, in real-time based on changes in the state 202 associated with the operating environment 402. In this example, the operating environment component 402 is a memory controller 106, and the operational parameters 134 are thresholds for enabling or disabling an OWT feature of the memory controller 106. However, it should be understood that the techniques described herein for adjusting operational parameters 134 in real-time are applicable to any processing system component or operational parameter 134.

During time interval T, a monitoring component 210 obtains the current state, S_{T}, of the operating environment 402. In this example, the state S_{T} includes the current number, C1_{T}, of pending writes to the memory controller 106, the current number, C2_{T}, of pool tokens available in a data channel to the memory controller 106, and the current number, C3_{T}, of pool tokens available in a request channel to the memory controller 106. The parameter tuning circuit 138 selects one or more operational parameter adjustment actions, A_{T}, based on the state S_{T} of operating environment 402 and one or more of the learned policies 206. The parameter tuning circuit 138 then performs the selected actions. For example, the parameter tuning circuit 138 increases a first threshold associated with the current number of pending writes to the memory controller 106, increases a second threshold associated with the current number of pool tokens available in a data channel to the memory controller 106, and decreases a third threshold associated with the current number of pool tokens available in a request channel to the memory controller 106. Therefore, in this example, for the OWT feature of the memory controller 106 to be enabled in a subsequent (or current) time interval, a greater number of pending writes, a greater number of pool tokens in the data channel, and a smaller number of pool tokens in the request channel are required than in the previous time interval.

After the parameter tuning circuit 138 adjusts the operational parameters 134, the monitoring component 210, measures the impact the action had on the operating environment 402. For example, the monitoring component 210 measures the impact of adjusting the OWT thresholds on memory performance. Based on the collected metrics 212, the monitoring component 210 sends a reward signal, R_{T}, to the parameter tuning circuit 138. In the example shown in FIG. 4, the monitoring component 210 is part of the operating environment 402 and, therefore, the reward signal, R_{T}, is sent from the operating environment 402 to the parameter tuning circuit 138. However, in other implementations, the monitoring component 210 is part of the parameter tuning circuit 138. The ML component 204 of the parameter tuning circuit 138 then updates the policy 206 based on the reward signal R_{T}.

During a subsequent time interval, T+1, the monitoring component 210 obtains a new current state, S_{T+1}, of the operating environment 402. In this example, the state S_{T+1} includes the current number, C1_{T+1}, of pending writes to the memory controller 106, the current number, C2_{T+1}, of pool tokens available in a data channel to the memory controller 106, and the current number, C3_{T+1}, of pool tokens available in a request channel to the memory controller 106. The parameter tuning circuit 138 then selects one or more operational parameter adjustment actions, A_{T+1}, based on the current state S_{T+1} of operating environment 402 and one or more of the learned policies 206. The parameter tuning circuit 138 then performs the selected actions. For example, the parameter tuning circuit 138 increases the first threshold, decreases the second threshold, and decreases the third threshold. Therefore, in this example, for the OWT feature of the memory controller 106 to be enabled in a subsequent (or current) time interval, a greater number of pending writes, a smaller number of pool tokens in the data channel, and a smaller number of pool tokens in the request channel are required than in the previous time interval T. After the parameter tuning circuit 138 adjusts the operational parameters 134, the monitoring component 210, measures the impact the action had on the operating environment 402 and sends a reward signal, R_{T+1}, to the parameter tuning circuit 138. The ML component 204 of the parameter tuning circuit 138 then updates the policy 206 based on the reward signal R_{T+1}. The above process is then repeated for a subsequent time interval T+2.

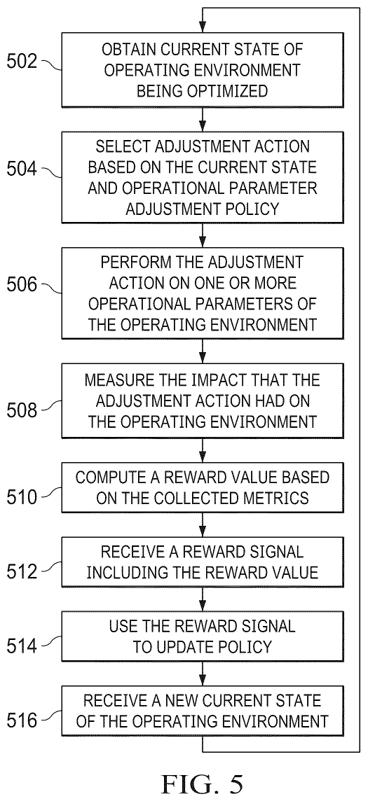

FIG. 5 is a diagram illustrating an example method 500 of adjusting operational parameters of a processing system component in real-time based on the current state of the component in accordance with at least some implementations. It should be understood that the processes described below with respect to method 500 have been described above in greater detail with reference to FIG. 1 to FIG. 4. For purposes of description, the method 500 is described with respect to an example implementation at the processing system 100 of FIG. 1, but it will be appreciated that, in other implementations, the method 500 is implemented at processing devices having different configurations. Also, the method 500 is not limited to the sequence of operations shown in FIG. 5, as at least some of the operations can be performed in parallel or in a different sequence. Moreover, in at least some implementations, the method 500 can include one or more different operations than those shown in FIG. 5.

At block 502, the parameter tuning circuit 138 obtains a current state 202 of the operating environment 402, such as a hardware component of the processing system 100. At block 504, the parameter tuning circuit 138 selects a first adjustment action to adjust one or more operational parameters 134 of the operating environment 402 based on a policy 206 that maps adjustment actions to a plurality of different states for the operating 542 environment. For example, in at least some implementations, the policy 206 is represented by one or more DNNs 218. In these implementations, the parameter tuning circuit 138 inputs the current state 202 of the operating environment 402 into the DNN 218. The DNN 218 outputs an operational parameter adjustment action or Q-values, which are values representing an expected future cumulative reward, for all possible adjustment actions. The parameter tuning circuit 138, based on the output and an exploration strategy (e.g., ε-greedy), selects an adjustment action.

At block 506′, the parameter tuning circuit 138 performs the adjustment action to adjust one or more of the operational parameters 134 of the operating environment 402. At block 508, the monitoring component 210, measures the impact the adjustment action had on the execution behavior of the operating environment 402. For example, the monitoring component 210 determines if the adjustment action resulted in positive execution behavior or negative execution behavior of the component. In the current example, the monitoring component 210 measures memory performance metrics, such as latency and throughput. At block 510, a reward function 214 computes a reward value 216, which includes either a reward or penalty, based on the collected metrics 212. At block 512, the parameter tuning circuit 138 receives a reward signal 208 including the reward value 216 from the monitoring component 210 (or another component).

At block 514, the parameter tuning circuit 138 uses the reward signal 208 to update the policy 206 or value function. For example, the parameter tuning circuit 138 adjusts the Q-value (or similar value) associated with the first adjustment action based on the reward signal 208. In another example, the parameter tuning circuit 138 computes a gradient of an objective function based on the reward signal 208 and parameters of the policy 206 that determine a likelihood of specific adjustment actions in the policy 206 to be selected. In this example, the reward signal 208 directly influences this gradient. Positive rewards push parameter updates in the direction that makes the chosen adjustment action more likely in the future, while negative rewards do the opposite. The parameter tuning circuit 138 then uses one or more optimization techniques, such as gradient descent, stochastic gradient descent, or the like, to update the policy parameters in the direction that is expected to increase future rewards. At block 516, the parameter tuning circuit 138 receives a new current state 202 of the operating environment 402. The method returns to block 504 and the parameter tuning circuit 138 selects a second adjustment action based on the new current state 202 and the policy 206. The parameter tuning circuit 138 then repeats the processes described above with respect to blocks 504 to 516.

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A processing system, comprising:
a plurality of hardware components; and
an operational parameter tuning circuit configured to:
perform, during a first time interval, a first adjustment action that adjusts one or more operational parameters of at least one hardware component of the plurality of hardware components based on a current state of the at least one hardware component and a policy that maps adjustment actions to a plurality of different states for the at least one hardware component.

2. The processing system of claim 1, wherein the operational parameter tuning circuit is further configured to:
perform, during a second time interval, a second adjustment action that adjusts the one or more operational parameters based on a new current state of the at least one hardware component and the policy.

3. The processing system of claim 1, wherein the operational parameter tuning circuit is further configured to:
update the policy in response to a change in execution behavior of the at least one hardware component resulting from the first adjustment action.

4. The processing system of claim 1, wherein the operational parameter tuning circuit is configured to update the policy by:
receiving a reward signal indicating a positive execution behavior or a negative execution behavior of the at least one hardware component resulting from the first adjustment action.

5. The processing system of claim 4, wherein the operational parameter tuning circuit is further configured to update the policy by:
adjusting a value in the policy representing an expected future cumulative reward associated with the first adjustment action based on the reward signal.

6. The processing system of claim 4, wherein the operational parameter tuning circuit is further configured to update the policy by:
computing a gradient of an objective function based on the reward signal and parameters of the policy that determine a likelihood of specific adjustment actions in the policy to be selected; and
updating the parameters of the policy based on the computed gradient to increase an expected reward from future selections of adjustment actions in the policy.

7. The processing system of claim 1, wherein the operational parameter tuning circuit is further configured to:
select the first adjustment action from the policy using one or more neural networks.

8. A method, comprising:
selecting, by an operational parameter tuning circuit during a first time interval and based on a current state of at least one hardware component of a processing system, a first adjustment action from a policy that maps adjustment actions to a plurality of different states for the at least one hardware component; and
performing, by the operational parameter tuning circuit during the first time interval, the first adjustment action to adjust one or more operational parameters of the at least one hardware component.

9. The method of claim 8, further comprising:
performing, by the operational parameter tuning circuit during a second time interval, a second adjustment action, that adjusts the one or more operational parameters based on a new current state of the at least one hardware component and the policy.

10. The method of claim 8, further comprising:
update, by the operational parameter tuning circuit, the policy in response to a change in execution behavior of the at least one hardware component resulting from the first adjustment action.

11. The method of claim 8, wherein updating the policy comprises:
receiving, by the operational parameter tuning circuit, a reward signal indicating a positive execution behavior or a negative execution behavior of the at least one hardware component resulting from the first adjustment action.

12. The method of claim 11, wherein updating the policy comprises:
adjusting, by the operational parameter tuning circuit, a value in the policy representing an expected future cumulative reward associated with the first adjustment action based on the reward signal.

13. The method of claim 11, wherein updating the policy comprises:
computing, by the operational parameter tuning circuit based on the reward signal, a gradient of an objective function based on the reward signal and parameters of the policy that determine a likelihood of specific adjustment actions in the policy to be selected; and
updating, by the operational parameter tuning circuit, the parameters of the policy based on the computed gradient to increase an expected reward from future selections of adjustment actions in the policy.

14. The method of claim 8, wherein selecting the first adjustment action comprises:
inputting, by the operational parameter tuning circuit, the current state of at least one hardware component into at least one neural network; and
outputting, by the neural network, the first adjustment action based on the current state.

15. A method, comprising:
selecting, by an operational parameter tuning circuit during a first time interval and based on a current state of a memory controller of a processing system, a first adjustment action from a policy that maps adjustment actions to a plurality of different states for memory controller; and
performing, by the operational parameter tuning circuit during the first time interval, the first adjustment action to adjust one or more thresholds for enabling or disabling an opportunistic write-through feature of the memory controller.

16. The method of claim 15, further comprising:
performing, by the operational parameter tuning circuit during a second time interval, a second adjustment action, that adjusts the one or more thresholds based on a new current state of the memory controller.

17. The method of claim 15, further comprising:
update, by the operational parameter tuning circuit, the policy in response to a change in execution behavior of the memory controller resulting from the first adjustment action.

18. The method of claim 15, wherein updating the policy comprises:
receiving, by the operational parameter tuning circuit, a reward signal indicating a positive execution behavior or a negative execution behavior of the memory controller resulting from the first adjustment action.

19. The method of claim 18, wherein updating the policy comprises:
adjusting, by the operational parameter tuning circuit, a value in the policy representing an expected future cumulative reward associated with the first adjustment action based on the reward signal.

20. The method of claim 18, wherein updating the policy comprises:
computing, by the operational parameter tuning circuit, a gradient of an objective function based on the reward signal and parameters of the policy that determine a likelihood of specific adjustment actions in the policy to be selected; and
updating, by the operational parameter tuning circuit, the parameters of the policy based on the computed gradient to increase an expected reward from future selections of adjustment actions in the policy.
